(19) United States
(12) Patent Application Publication
(10) Pub. No.: US 2025/0045891 A1
(43) Pub. Date: Feb. 6, 2025

(54) IMAGE ENHANCEMENT AND OBJECT DETECTION SYSTEM FOR DEGRADED UNDERWATER IMAGES USING ZERO-REFERENCE DEEP CURVE ESTIMATION and G-UNET

(71) Applicant: Ashish GHOSH, Kolkata (IN)

(72) Inventors: Ashish GHOSH, Kolkata (IN); Meghna KAPOOR, Nagrota, (IN); Ankur BANSAL, Nagrota (IN); Badri N. SUBUDHI, Nagrota (IN); Vinit JAKHETIYA, Nagrota (IN); T. VEERAKUMAR, Ponda (IN)

(21) Appl. No.: 18/230,642

(22) Filed: Aug. 6, 2023

(51) Int. Cl. G06T 7/00; G06V 10/44; G06V 10/56; G06V 10/60; G06V 20/52

(52) U.S. Cl. CPC G06T 7/0002; G06V 10/44; G06V 10/56; G06V 10/60; G06V 20/52; G06T 2207/10024; G06T 2207/20084; G06T 2207/20192; G06V 2201/07

(57) ABSTRACT

An image enhancement and object detection system is provided to enhance the degraded images and bring out the inherent details of the image received via an underwater surveillance system. The said system includes a novel deep learning architecture i.e., a Zero-DCE-U that enhances the degraded underwater images using modified UIQM. Further, a new training method using a single image based on correlation is employed. Furthermore, a G-UNet architecture is configured to detect moving objects while preserving the spatial-contextual relationships.

### TECHNICAL FIELD

The present invention relates to the field of image enhancement and object detection in video/images, and more particularly to image enhancement system for degraded/deteriorated unpaired underwater videos using zero-reference deep curve estimation ZeroDCE-U (Zero Deep Curve Estimation for Underwater) architecture. Further, to underwater moving object detection using G-UNet (Graph Convolution U Network)

### DESCRIPTION OF THE RELATED ART

Underwater surveillance is one of the emerging areas in computer vision due to its various applications. It includes the inspection of ship hulls, bridge pilings, dams, and offshore oil structures or pipelines. However, due to the possible existence of toxic and lethal compounds, in particular, human engagement for the inspection is not safe. Therefore, the employment of submersible robotics platforms or the deployment of unmanned underwater vehicles provides a more effective and efficient solution to the problem of underwater inspection. Due to underwater dynamics, videos shot in the underwater environment are deformed and suffer from low contrast, blurriness, and loss of information such as edge details, among etc. Further, as we go deeper, the light starts losing energy. Moreover, the underwater environment is minimally illuminated hence the captured videos are under low light conditions. This makes it difficult to distinguish the minute details of objects present underwater. In recent years, automated video-based monitoring, surveying, and mapping have all been identified as the most significant capabilities of autonomous underwater vehicles (AUVs) and remotely operated vehicles (ROVs), for ocean and seafloor exploration. The purpose is to process the video imagery as it is acquired live in order to calculate the position of the AUV or ROV relative to the target of interest and to automatically travel under computer control in order to inspect and map the various components of the target structure. While the lack of natural lighting at depth can provide major obstacles in deep-sea operations, other serious complexities in computer processing and video analysis can occur in shallow waters during automated inspection. Further, surface waves create disruptions in shallow seas, casting shadows on the structure/marine life to be photographed/filmed. In some situations, such as when the target surfaces have poor texture, these shadow artifacts can overpower the image fluctuations caused by camera motions, which are the major visual cues for identifying motion information. Other complications occur from the movement of floating suspended particles and water bubbles, which are common in shallow seas.

In conventional image processing, the images are enhanced by governing a gamma coefficient of the power law. However, tuning the gamma parameter can be cumbersome. Accordingly there is a need of an image enhancement and object detection system end for Underwater Surveillance utilizing Zero-DCE-U and G-UNet to enhance the degraded images and bring out the inherent details of the image received via underwater surveillance system. As enhancing the video frames helps to identify the moving objects better for underwater surveillance. The current state-of-the-art methods focus on either improving the image quality or detecting objects from the scene however, the present invention provides an end-to-end algorithm for image enhancement and object detection.

### SUMMARY OF THE INVENTION

According to an aspect of the present invention, an image enhancement and object detection system is provided. The image enhancement and object detection system introduces an end-to-end architecture for autonomous vehicle navigation, which includes a novel ZeroDCE-U (Zero Deep Curve Estimation for Underwater) architecture to enhance the degraded unpaired underwater images by governing the power law coefficient. According to the power law, the output image is enhanced by altering the value of gamma, i.e. power of the degraded input image. The value of gamma (power law coefficient) is adjusted empirically, which is quite a cumbersome task. A convolutional neural network named Deep Curve Estimation (DCE-net) is deployed to generate the power curves. The generated curve parameter are iteratively updated to generate enhanced images. The network converges with no-reference or zero reference image. Furthermore, integration of perceptual loss, namely, modified underwater image quality measure (UIQM), compensates for the losses and enhances the degraded image. The underwater image quality measure (UIQM) module, which is a combination of underwater image colour measure (UICM) module, underwater image contrast measure (UiConM) module, and underwater image sharpness measure (UISM) module along with exposure and illumination is utilized as a cost function to generate visually appealing images and compensate for the degradation due to underwater dynamics. The deep learning-based models extract the features from the given frame and capture the distribution to generate distortion-free images. The frames of a video have a high correlation, we used this to train our proposed model using a single image. The Resnet-50 backbone in U-Net architecture is configured, which labels the pixel as either background or foreground. A U-Net architecture comprises of encoder and decoder and decoder is an inverted replica of encoder. The architecture looks like the letter ‘U’ hence the name. The latent information is heavily relied on size of convolutional kernel and stride. A graph convolutional network is introduced in latent space to refactor the node relationships. A G-UNet architecture is configured to detect moving objects while preserving the spatial-contextual relationships.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The disclosure will provide details in the following description of preferred embodiments with reference to the following figures wherein:

FIG. 1 shows an exemplary block representation of image enhancement and action detection system in accordance with an embodiment of the present invention.

FIG. 2 shows an exemplary block representation of ZeroDCE-U architecture for underwater image enhancement in accordance with an embodiment of the present invention.

FIG. 3 shows an exemplary block representation of G-UNet architecture for moving object detection in accordance with an embodiment of the present invention.

FIG. 4 shows an exemplary flowchart defining the sequential working steps of the image enhancement and action detection system in accordance with an embodiment of the present invention.

FIG. 5 shows qualitative analysis of ZeroDCE-U (Zero Deep Curve Estimation for Underwater) with five SOTA (State of the Art techniques) techniques.

FIG. 6 shows qualitative analysis of proposed object detection framework on Fish4Knowledge database.

### DETAILED DESCRIPTION OF PREFERRED EMBODIMENTS

Embodiments of the present invention are described below by way of example only. These examples represent the best ways of putting the invention into practice that are currently known to the Applicant although they are not the only ways in which this could be achieved. Forth the functions of the example and the sequence of steps for constructing and operating the example.

The present invention is directed to an image enhancement and object detection system incorporated in an autonomous vehicle for underwater inspection.

In an embodiment, the present invention solves the fundamental problem of underwater surveillance.

In an embodiment, the present invention utilizes an end-to-end architecture consisting no-reference Zero Deep Curve Estimation network for Underwater (Zero DCE-U) and Graph U-Net module for moving object detection and enhancing the degraded underwater images using modified Underwater Image Quality Measure (UIQM).

In an embodiment, the present invention is applied to underwater object detection in video. Further, the present invention is not limited to solely detection of an object in a video and can be applied to other types of recognition, as readily appreciated by one of ordinary skill in the art given the teachings of the present invention provided herein, while maintaining the spirit of the present invention.

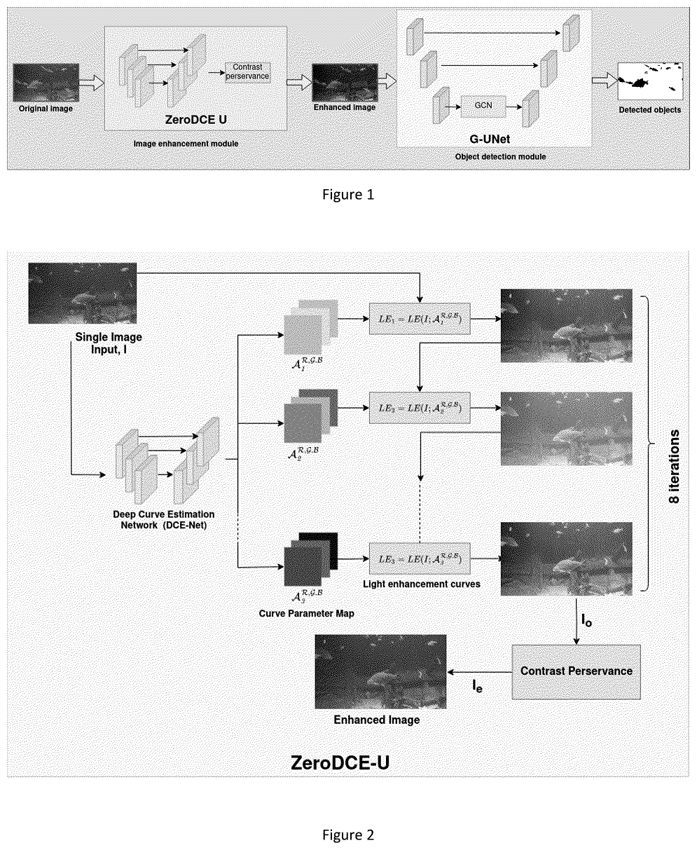

FIG. 1 shows an exemplary system for image enhancement and object detection where raw frames are extracted from the given underwater videos and a non-reference Zero-DCE approach is applied to enhance these frames followed by a Graph U-Net module includes an architecture to detect moving objects in complex underwater scenarios in accordance with an embodiment of the present invention. In the first stage, the degraded underwater video frames are fed into the image enhancement module. A non-reference zero deep curve estimation for underwater (ZeroDCE-U) is used to retrieve enhanced images. The image enhancement module comprises of ZeroDCE-U and contrast perseverance module wherein ZeroDCE-U is utilized for enhancing the image and the enhanced images are fed to contrast perseverance module. The quality of the generated image is trained by increasing the virtual perception of image. The underwater image quality metric depicts the visual enhancement of image and comprises underwater image colour measure (UICM) module, underwater image contrast measure (UiConM) module, and underwater image sharpness measure (UISM) module. A modified underwater image quality metric including the exposure and illumination is explored as the loss function of the algorithm. Further, a Graph U-Net module is deployed to detect moving objects in complex underwater scenarios. The contrast of the image is maximised by evaluating the distribution of histogram and removing a cut-off percentage from the histogram. The enhanced image is fed into Graph U-Net module where the encoder projects the image into high-dimension latent space and extract the features in form of latent vectors. The latent vectors are re-factored using graph convolutional module to detect the moving objects. The latent vectors are the higher-order vectors obtained at the end of the encoder by flattening the matrix. The G-UNet module includes an encoder-decoder type architecture where the encoder extracts the feature of the image and projects them into latent space using a convolutional neural network. The graph convolutional network re-factors the node relationship. Here, a node is an element of the feature vector. Refactoring is done by projecting the latent space in graph space and performing graph convolutions in non-euclidean space. The vector is fed into the decoder network, which projects the latent vector to the image space.

The underwater inspection system comprises a video/image capturing device configured to capture an underwater video sequence or image and a server operatively coupled with the video/image capturing device. The server further comprises a video/image extractor to receive captured video sequence for generating a plurality of image frame from a sequential video sequence, a transceiver operatively coupled with video extractor to receive the extracted action video frames and send to one or more processors for processing the video sequence, one or more processors coupled with memory unit and graphics processing unit. The processor further includes an image enhancement module configured to enhance the underwater image frame of movement video sequence.

The system includes a video/image capturing device whereas multiple video capturing device such as a wired or wireless, underwater or waterproof camera/video==recording system can be used to realize the objective of the present invention. The underwater video captured (256×256) via the video capturing device may be a degraded underwater action video sequence. Further the image captured by the image capturing device may be disrupted by the sea waves.

The system also includes a server configured to perform image enhancement and object detection in underwater videos or in underwater images. The object detection can involve detecting the presence of objects (e.g., underwater structure, marine life or cracks in structure). The server can be located remote from, or proximate to, the video capturing device. The server can include one or more processors, a video extractor, a memory unit, and a transceiver. The server may also include other components necessary for functioning of the above mentioned components i.e., stand/holder for placing video capturing device, wires, switches, display unit, LAN/WLAN, Bluetooth, etc. However, for the sake of brevity they are not discussed in detail.

The video extractor is configured to receive the image/video sequence captured via the video capturing device, to generate a plurality of image frame of an action video sequence. In an exemplary embodiment, the video extractor employed in the present innovation is a fast forward moving picture experts group (FFMPEG). It is a free and open-source software project that provides a wide range of video and audio processing features. However, the video extractor may be any video extractor fulfilling the requirement of the hardware employed for the present invention.

The transceiver is configured to receive the extracted images/action video sequence frames from the video extractor and send the extracted action video frames to one or more processors for processing the video sequence. A transceiver may be used in a wireless or wired communication device for transmitting the information, i.e., extracted action video frames to one or more processors.

The memory unit (such as random access memory (RAM) or read only memory (ROM)) in the present invention is coupled with processor to monitor one or more control signals of the processors. Further the size of the memory unit may depend upon the requirement of the user to realize the objective of the present invention.

The one or more processors includes an image enhancement module and object detection module. The image enhancement module includes an enhancement curve prediction machine learning model i.e., a Zero-DCE-U a lightweight deep network model configured to estimate plurality of pixel-wise enhancement curves for the sequential frames extracted from the underwater videos. Further, the image enhancement module includes a contrast preservance model. The image enhancement architecture may cause loss in original details and features of the image. So the contrast preservance model helps in preserving the contrast of the image during the extraction process. The enhanced image from ZeroDCE-U is fed to contrast perseverance module, where the histogram of enhanced image is considered and the highest and lowest values are cut-off to generate a high contrast image.

FIG. 2 shows an exemplary representation of Zero-DCE-U. The model in the present invention uses a single image training so the first frame of video is fed to the Deep curve estimation network to estimate the curve parameter maps. The light enhancement curves are generated iteratively eight times, and the eighth image is fed to the contrast perseverance module. The contrast is preserved using removing the cut-off percent from highest and darkest histogram and the enhanced image is generated.

In an embodiment the input frame is resized to 256×256. ZeroDCE-U enhances the image by generating light enhancement curves iteratively. These are the projection map that takes the pixel values and map them between [0,1]. The light enhancement curves generated by DCE-net are monotonous in order to be differentiable in the backward pass. Light enhancement curves normalize the pixel intensities while maintaining neighborhood relationships. The underwater images are blurred, with poor contrast, and the edge details are mostly lost. Further, the scene can have uneven exposure and illumination due to artificial light sources present in the water body. A modified UIQM loss function is implemented to evaluate the loss and hence back propagate the errors. The modified loss function is mainly a weighted sum of colorfulness, sharpness, contrast measure, exposure loss, and illumination loss. The loss function with each component is mentioned briefly below.

UICM: Underwater Image Colorfulness Measure (UICM) module is used to compensate for the color degradation in underwater images. To evaluate UICM, $\alpha$ trimmed mean and variance across Red-Green and Yellow-Blue channels are used. Alpha ($\alpha$) trimmed filters are used to remove the additive Gaussian noise by removing a fixed fraction $\alpha$ from the high to low end are defined as,

$$UICM = - 0.0268 \sqrt{{μ}_{α , RG}^{2} + {μ}_{α , YG}^{2}} + 0.1586 \sqrt{{σ}_{α , RG}^{2} + {σ}_{α , YG}^{2}}$$

where the Alpha (α) trimmed mean (μ) and variance (σ) along Red-Green (RG) represented by μ_{α,RG}, σ_{α,RG} and Yellow-Blue (YB) color component represented by μ_{α,YB}, σ_{α,YB} respectively is used for compensation.

UISM: Underwater Image Sharpness Measure (UISM) module is used to preserve the fine details and edges. Sobolev norm is applied to detect edges in the image. The weighted ($\lambda$) sum of enhancement measure estimation (EME) is used across all three channels (c). The image is divided into blocks of size mn. To estimate EME, the relative contrast ratio (I_{max k,l}/I_{min k,l}) in mn block is used.

$$UISM = {\sum }_{c = 1}^{3} {λ}_{c} {EME ( grayscale edge )}_{c} \\ EME = \frac{2}{mn} {\sum }_{j = 1}^{m} {\sum }_{i = 1}^{n} log ( \frac{{I}_{max , i , j}}{{I}_{min , i , j}} )$$

Here c is a channel, Iₘₐₓ is the maximum intensity, and Iₘᵢₙ is the minimum intensity. λ is a constant and λ_{R}=0.29, λ_{G}=0.58, λ_{B}=0.11.

UIConM: Underwater Image Contrast Measure (UIConM) module is used to enhance the contrast. Due to suspended particles in the water medium, a portion of light interacts with the particles without reaching the object and changes its path. This diverted light is captured by the camera; inducing back-scattering. It, in turn, limits the contrast of the image. The contrast measurement is done with log AMEE measure in block mn. The parameterized logarithmic image processing operations are the ⊕, ⊖, and ⊗.

UIConM=log AMEE(Intensity).

$$logAMEE = \frac{1}{mn} ⊗ {\sum }_{j = 1}^{m} {\sum }_{i = 1}^{n} \frac{{I}_{max , i , j} ⊖ {I}_{min , i , j}}{{I}_{max , i , j} ⊕ {I}_{min , i , j}} log log ( \frac{{I}_{max , i , j} ⊖ {I}_{min , i , j}}{{I}_{max , i , j} ⊕ {I}_{min , i , j}} )$$

Exposure Module: Exposure Loss (Lₑₓₚ) This loss measures the distance between the average intensity value of a local region and the level of well-exposure E. The exposure control loss can be expressed as,

$${L}_{exp} = \frac{1}{M} {\sum }_{k = 1}^{M} \vert {Y}_{k} - E \vert .$$

Here, K is the number of local regions, Y is the average intensity of the local region in an enhanced image, and M is the number of overlapping regions.

Illumination Module: llumination smoothness Loss (Lₜᵥ_{_{A}}): The light enhancement curves should be monotonous to be differentiable. Illumination smoothness loss preserves the monotonicity of these curves. The illumination smoothness loss Lₜᵥ_{_{A}} can be expressed as:

$${L}_{{tv}_{A}} = \frac{1}{N} {\sum }_{n = 1}^{N} {\sum }_{c ∈ ξ} {( \vert {Δ}_{x} {A}_{n}^{c} \vert + \vert {Δ}_{y} {A}_{n}^{c} \vert )}^{2} , ξ = \{ R , G , B \}$$

Here, N is the number of iterations, Δₓ and Δ_{y} are gradients across the x and y direction, and A is the estimated curve map.

The total loss (Lₜₒₜₐₗ) function computed by the weighted sum of all the above-mentioned measures can be given as,

$${L}_{total} = {W}_{uicm} {L}_{uicm} + {W}_{uism} {L}_{uism} + {W}_{uiconm} {L}_{uiconm} + {W}_{exp} {L}_{exp} + {W}_{{tv}_{A}} {L}_{{tv}_{A}}$$

Here, W_{uicm}, Wᵤᵢₛₘ, W_{uiconm}, Wₑₓₚ, and Wₜᵥ_{_{A}} are the weights corresponding to UICM, UISM, UIConM, exposure, and illumination smoothness respectively.

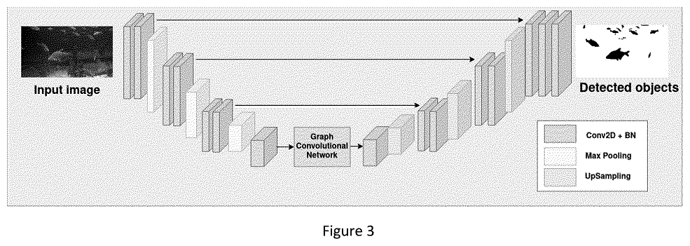

FIG. 3 shows an exemplary representation of G-UNet architecture for moving object detection. The enhanced images are fed to the encoder of Graph Convolutional U Network (G-UNet). The enhanced video frame is fed to the encoder part of G-UNet that consists of convolutional layers and pooling layers. The encoder generates a latent vector and are re-factored using graph convolutional neural network. The refactored vector is fed to the decoder consisting of convolutional layers and up-sampling layers to detect the moving object from the scene.

The U-Net architecture is based on ResNet 50 backbone. Here, the left part in the U structure is an encoder module that uses convolution and pooling layers for the feature extraction (down sampling) from the given input image. The right part is a decoder module that uses the up-sampling techniques and convolutions on extracted features from the encoder and generates the required image. In between the encoder and decoder part, to regenerate the relationship between nodes which is in non-euclidean space, we propose the use of a GCN module and hence, we name our model as G-UNet.

Moreover, a U-Net architecture is used to detect the moving object. Further. the graph convolutional networks are used in the latent space of U-Net architecture to preserve the information in latent space.

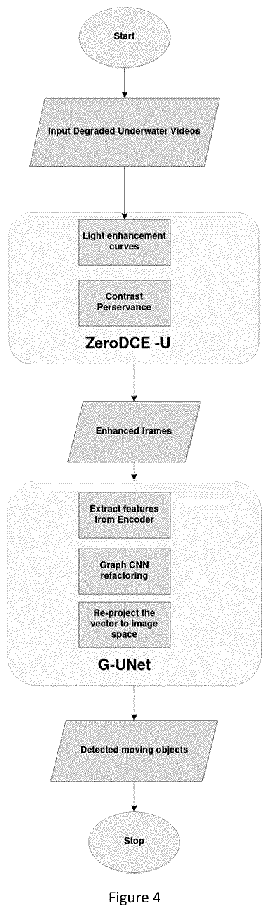

In an exemplary embodiment a method for performing underwater inspection summarized in FIG. 4 herein comprises the following steps:
capturing the video sequence from the underwater environment;
extracting the video frames;
initializing the ZeroDCE-U from the first frame to generate light enhancement curves iteratively;
utilizing contrast perseverance module for enhancing the contrast of the image.
feeding the enhanced frames are fed to the encoder to generate the latent space vector and graph convolutional neural network refactor;
feeding the vector to the decoder to detect moving objects in the video frames; and
learning of ZeroDCE-U is performed over a single frame, i.e. the first frame of the video sequence.

In an embodiment the ZeroDCE-U as shown in FIG. 2 uses modified UIQM as a loss function and incorporates colourfulness, sharpness, contrast, exposure and illumination loss. The total loss is the sum of all these losses with a weight value of W_{uicm}=1, Wᵤᵢₛₘ=1, W_{uiconm}=1, Wₑₓₚ=2, and Wₜᵥ_{_{A}}=5, respectively. The model is trained using Adam optimizer with a learning rate of e⁻³. For G-UNet present in FIG. 3, ResNet 50 backbone is used to extract the features. The model is trained for 100 epochs with a learning rate of with e⁻⁴ Adam optimizer.

In an exemplary embodiment the ZeroDCE-U architecture is implemented on a Quadro P2200 GPU in the Keras framework with a Tensorflow backend. Further, the G-Unet architecture is trained using the Pytorch framework in an NVIDIA Tesla T4 system. The model is tested against seven state-of-the-art methods on EUVP dataset in terms of underwater image quality metric and found that the model performed best with a UIQM score of 3.37.

In an embodiment the performance of the image enhancement and object detection system is evaluated in terms of the underwater image quality metric (UIQM). The state-of-the-art methods have attained the highest UIQM score of 2.81 whereas, the present invention model known as ZeroDCE-U has the highest UIQM score of 3.37. Hence, it is able to produce a sharp image with the highest information without any need for a reference image.

The moving object detection algorithm is tested for precision, recall and average F-measure. Whereas the highest state of the art has the highest F-measure of 0.87, our proposed algorithm gave a state-of-the-art performance with an F-score of 0.99. Hence, preserving most of the structural information.

TABLE 1
Quantitative results of proposed
Zero-DCE-U model in terms of UIQM

| Model | UIQM score | Std Deviation |
|---|---|---|
| Res-WGAN | 2.46 | 0.67 |
| Res-GAN | 2.62 | 0.89 |
| LS-GAN | 2.59 | 0.52 |
| PIX2PIX | 2.76 | 0.39 |
| UGAN-P | 2.77 | 0.34 |
| Cycle GAN | 2.62 | 0.67 |
| FUNIE GAN | 2.81 | 0.65 |
| ZeroDCE(conventional) | 2.94 | 0.47 |
| ZeroDCE + contrast | 2.95 | 0.46 |
| (conventional) | | |
| ZeroDCE (single image) | 3.03 | 0.04 |
| (conventional) | | |
| ZeroDCE-U | 3.02 | 0.04 |
| ZeroDCE-U(contrast) | 3.37 | 0.04 |

In an embodiment Table 1 depicts the quantitative analysis of the said processes on the EUVP dataset. The Enhancing Underwater Visual Perception (EUVP) dataset consists of paired and unpaired dataset. The EUVP dataset consists of samples from underwater dark, underwater image net, and underwater scenes. The ZeroDCE-U with contrast preservance and single image training not only generalizes the distribution but also preserves the sharpness of the image with the help of a modified UIQM cost function. The model is tested against seven state-of-the-art underwater image enhancement algorithms and five variants of ZeroDCE-U. ZeroDCE-U with contrast perseverance block performed best among all the methods with a UIQM score of 3.37. The proposed model uses underwater IQA as a cost function, hence the generated images are found to be providing better accuracy in terms of considered visual and quantitative evaluation measures.

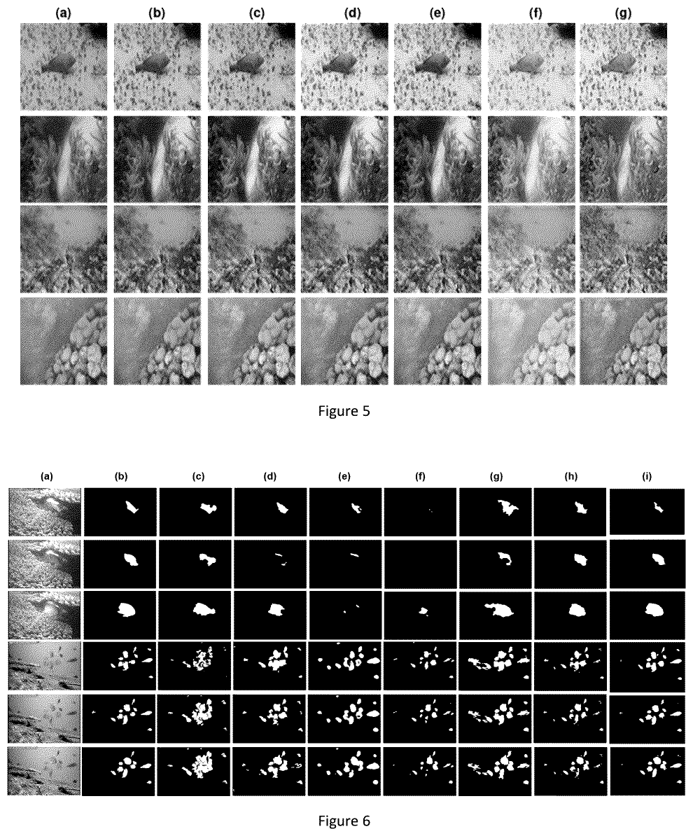

In an embodiment FIG. 5 depicts the qualitative analysis of ZeroDCE-U with five SOTA techniques. Here, Column (a) has input images, (b) Deep SESR, (c) FUnIE-GAN, (d) UGAN, (e) UGAN-P, (f) ZeroDCE (conventional), and (g) ZeroDCE-U. The proposed method is preserving the minute details while increasing the contrast of the image. The blue hue is reduced and perceptually appealing images are generated.

In an embodiment the G-Unet architecture is tested against six state-of-the-art methods in fish4Knowledge dataset and eight state-of-the-art methods on underwater change detection net in terms of Precision, recall and average f-measure. It is observed that the mode of the present invention gives state-of-the-art performance with F-measure of 0.99.

TABLE 2
Quantitative Results of G-UNet
on Fish4Knowledge Dataset

| Models | Average F-Measure |
|---|---|
| TBGS | 0.62 |
| MLCB | 0.67 |
| SEBS | 0.56 |
| SITP | 0.66 |
| MFI | 0.79 |
| MSB | 0.85 |
| PM | 0.99 |

In an embodiment Table 2 represents the average f-measure of the proposed method with six deep learning-based methods. The proposed object detection framework has obtained propitious performance and could be considered efficient in detecting objects (fishes) in underwater/oceanic environments.

TABLE 3
Quantitative Results of G-UNet
on underwater change detection

| Method | Precision | Recall | F-measure |
|---|---|---|---|
| EB | 0.528 | 0.6996 | 0.5732 |
| GW | 0.7410 | 0.7762 | 0.7567 |
| ABL | 0.5254 | 0.7314 | 0.5890 |
| GMM | 0.7552 | 0.8126 | 0.7861 |
| KDE | 0.3441 | 0.7051 | 0.4216 |
| SuSENSE | 0.8520 | 0.8375 | 0.8411 |
| Vu Meter | 0.7181 | 0.7139 | 0.7089 |
| Wronksian | 0.8798 | 0.8646 | 0.8708 |
| Proposed | 0.9846 | 0.9985 | 0.9915 |
| Proposed(Enhanced) | 0.9898 | 0.9968 | 0.9933 |

In an embodiment Table 3 represents the quantitative analysis of the proposed model on the test set from the Fish4Knowledge database against eight conventional state-of-the-art methods. The method of the present invention is able to detect the foreground and background pixel more effectively than the existing state-of-the-art methods

In an embodiment FIG. 6 depicts the qualitative analysis of proposed Object detection framework on Fish4Knowledge database. Here, column (a) has original images, (b) ground truth, (c) Texture-BGS, (d) ML-BGS, (e) MultiCueBGS, (f) SubSENSEBGS, (g) SILTP, (h) MFI, (i) Proposed Method. The state-of-the-art methods fail to preserve the minute details and in most of the cases fail to detect the object at all. The proposed method preserves the minute details of moving object and is able to detect the moving object more clearly.

Accordingly, some exemplary suitable environments to which the present invention can be applied can include any environments where high quality imaging is essential for accurate analysis and decision making such as marine biology, underwater archaeology, underwater search and rescue operations and so forth. It is to be appreciated that the preceding environments are merely illustrative and, thus, other environments can also be used, while maintaining the spirit of the present invention. Any action type of interest can be recognized, depending upon the implementation. For example, the action may include, but is not limited to, one or more of the following: automated surveillance and so forth. It is to be appreciated that the preceding actions are merely illustrative.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. An image enhancement and object detection system for degraded videos/images comprising:
a video/image capturing device configured to capture the underwater sequence or an image;
a server operatively coupled with the video/image capturing device wherein the server comprises:
a video extractor to receive captured video sequence for generating a plurality of image frame from a sequential underwater video sequence;
a transceiver operatively coupled with video extractor to receive the extracted underwater video frames and send to one or more processors for processing the video sequence;
one or more processors coupled with memory unit wherein the processor comprises
an image enhancement module configured to enhance the degraded image frame of underwater sequence;
a Graph U-Net module configured to detect moving objects; and
a modified Underwater Image Quality Measure (UIQM) module configured to enhance the image quality.

2. The system for degraded videos of claim 1 comprising:
an image enhancement module including
a convolutional neural network-based module configured to generate light enhancement curves with varied gamma values to generate enhanced images without any reference image; and
a contrast preservance model configured to preserve the contrast of the image during extraction process.

3. The system for degraded videos of claim 1 comprising:
a modified Underwater Image Quality Measure (UIQM) module including
an Underwater Image Colorfulness Measure (UICM) module configured to compensate for the color degradation in underwater images;
an Underwater Image Sharpness Measure (UISM) module configured to preserve the fine details and edges; and
an Underwater Image Contrast Measure (UIConM) module configured to enhance the contrast;
an exposure module configured to handle the over and under exposedness of the image; and
an underwater illumination module configured to compensate for the irregular illumination in scene

4. The system for degraded videos of claim 1 comprises the G-UNet module including
an encoder-decoder type architecture wherein
the encoder is configured to extract the feature of the image and projects them into latent space via convolutional neural network;
GCN module is configured to refactor the node relationship in latent space; and
the decoder is configured to project the latent vector to the image space.

5. The system for degraded videos of claim 1 wherein the underwater video sequence captured via video capturing device is a degraded video sequence.

6. A method for performing moving object detection for degraded videos/images comprising the steps of:
capturing the video sequence from the underwater environment;
initializing the ZeroDCE-U from the first frame to generate light enhancement curves iteratively;
utilizing contrast perseverance module for enhancing the contrast of the image;
feeding the enhanced frames are fed to the encoder to generate the latent space vector and the latent vectors are refactored using graph convolutional neural network; and
feeding the vector to the decoder to detect moving objects in the video frames; and

7. The method for performing moving object detection for degraded videos/images of claim 6 wherein one or more processors is configured to provide an image enhancement module for enhancing the degraded image frame of underwater sequence.

8. The method for performing moving object detection for degraded videos/images of claim 6 wherein one or more processors is further configured to provide a Graph U-Net module for detecting moving objects.

9. The method for performing moving object detection for degraded videos/images of claim 6 wherein one or more processors is further configured to provide a modified Underwater Image Quality Measure (UIQM) module configured to enhance the image quality.
